(19) United States
(12) Patent Application Publication
(10) Pub. No.: US 2026/0114681 A1
(43) Pub. Date: Apr. 30, 2026

(54) CLEANING APPARATUS CONFIGURATIONS

(71) Applicant: Steven Jerome Caruso, Antioch, IL (US)

(72) Inventor: Steven Jerome Caruso, Antioch, IL (US)

(21) Appl. No.: 18/781,812

(22) Filed: Jul. 23, 2024

Related U.S. Application Data
(60) Provisional application No. 63/528,406, filed on Jul. 23, 2023.
(60) Provisional application No. 63/608,239, filed on Dec. 9, 2023.

(51) Int. Cl. A47L 7/00; B01D 39/16

(52) U.S. Cl. CPC A47L 7/0014; B01D 39/1623; B01D 2252/205

(57) ABSTRACT

New and novel structure(s) for cleaning surfaces have been disclosed. The invention at hand inventively improves upon the known devices in this field.

### RELATED APPLICATIONS

This application claims the benefit of U.S. provisional application Ser. No. #63/528,406 filed on Jul. 23 , 2023 and also provisional application Ser. No #63/608,239 filed on Dec. 9, 2023.

Each application in this paragraph is incorporated here by reference in its entirety to provide continuity of disclosure. As such, the entire disclosure of all applications are hereby incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates generally to devices for wet and dry cleaning of surfaces.

In the art of devices for cleaning surfaces, there exists a multitude of appliances that each serve a particular function. There are vacuums (that may or may not include a brush roll), there are sweepers (brush-roll only devices), and there are mops and wiper devices and devices referred to as deep cleaners which are often used for soft surfaces such as carpets or upholstery. These devices to date have limitations and the invention at hand improves on one or more of the aforementioned categories.

### BRIEF SUMMARY OF THE INVENTION

The present invention is a new and novel structure(s) for cleaning surfaces. Embodiments may selectively include; a fresh fluid reservoir, a fluid dispenser, a vacuum generating system, controls for selectively operating modes, and a soiled debris and fresh fluid reservoir either of which may made be made disposable or of a disposable, compostable/biodegradable, recyclable materials and/or construction. The structure and arrangement of disclosed embodiments are unique in the state-of-the-art.

### BRIEF DESCRIPTION OF SEVERAL VIEWS OF THE DRAWINGS

FIG. 1—is a Trimetric view of the invention.

FIG. 2—is a Trimetric view of the invention.

FIG. 3—is a Top view of the invention without the front end assembly 1.

FIG. 4 is a side view of the invention.

FIG. 5A are trimetric views of the invention.

FIG. 5B is a trimetric view, a front view, and a side sectional view of the invention.

FIG. 6 is a Trimetric view of the invention.

FIG. 7 is a Trimetric view of the invention.

FIG. 8 is a Trimetric view of the invention.

FIG. 9 is a Trimetric view of the invention.

FIG. 10 is a Trimetric view of the invention.

FIG. 11 is a Trimetric view of the invention.

FIG. 12 is a Trimetric view of the invention.

FIG. 13 is a Trimetric view of the invention

FIG. 14 is a side view of the invention

FIG. 15 is a Trimetric view of the invention

FIG. 16 is a side view of the invention

FIG. 17 is a Trimetric view of the invention

FIG. 18 is a side view of the invention

FIG. 19 is a Trimetric view of the invention

FIG. 20 is a Trimetric view of the invention

FIG. 21 is a Trimetric view of the invention

FIG. 22 is a Trimetric view of the invention

FIG. 23 is a Trimetric view of the invention

FIG. 24 is a Trimetric view of the invention

FIG. 25A is a Trimetric view of the invention

FIG. 25B is a Trimetric view of the invention

FIG. 26 is a Trimetric view of the invention

FIG. 27 is a Trimetric view of the invention

FIG. 28 is a side view of the invention

FIG. 29 is a trimetric view of the invention

FIG. 30 is a trimetric view of the invention

### REFERENCE CHARACTERS USED

The following reference characters are used in the drawings of refer to the parts of the present invention. Like reference characters indicate like or corresponding parts in the respective views.
1—One example of a Front End Assembly—FEA
2—Handgrip
3—Hose-fluid delivery, and/or power
4—Electrical wiring loom, power for vacuum motor and switch control for pump
5—magnets/clips
6—Power pack/base module i.e. may be formed as base module that the tanks attach to or sit in/on, or as depicted as a “saddle” or component that attaches to a tank. May include fresh fluid pump, batteries, transformers/power management for recharging and Transformers/power management for A.C. line powered usage. In some embodiments may also include a powered impeller for vacuum based fluid pickup via a hose set 3.
7—Tank(s) permanent or consumable/disposable
8—Tank Cap and/or draw tube entry
9—Carry Handle and/or Handgrip/of 7
10—Vacuum head/body assembly of shroud/motor/impeller and/or an end point/coupling of a vacuum hose.
11—Intake of 10
12 Part/surface of Front End Assembly (reference character 1)
13 Part/surface of Front End Assembly (reference character 1)
14 Part of Front End Assembly-Baffle (reference character 1)
15—Part of Front End Assembly (reference character 1)
16—First unit/working end
17—Second unit/working end
18—Sprayer Assembly
19—Nozzle of 18
20—Dispense button of 18
21—Vacuum button
22—Powered brush button/some embodiments contemplate 21 and 22 being conjoined in functionality.
23—Vacuum assembly (impeller and housing)
24—Vacuum motor
25—Tether section
26—Air out path of 15
27—Attachment rim of 10
28—Tab of 27
29—Optional locking ramp of 28
30—Vacuum motor
31—Intake area/nozzle
32—Waste area, well/expansion tank/holding tank/soiled fluid reservoir
33—Scoop(er)
34—Exemplary perforated break line
35—Snap Detail
36—Path of 23
37—draw tube for insertion to cleaning fluid containers
38—Over cap for 8
39—material web
40—Master box for receiving a consumable/semi-consumable element(s)
41—disposable liner/Waste area, well/expansion tank/holding tank/oiled fluid reservoir (may be of soft material or rigid/semi rigid construct.)
42—Hinge of 40
43—Attenuation valve, to control amount of total suction front end assembly 1, experiences to avoid fluid escaping 1, to the rest of the system, and/or to induce a pulsation of suction into the system to maximize fluid retrieval, by the remainder of the system (duct from front end assembly to the suction motor) having a suction build-up battery effect.
44—planer brush; finned or bristled
45—Rotary brush bristled
46—Rotary brush finned
47—Gear(s)
48—Gear Brush Combination
49—Milk carton styled construct
50—Plastic molded spout
51—formed/punched keyhole leg
52—Slide on hooks
53—Slide on hooks
54—Mangle gear assembly or offset crank assembly to impart reciprocating motion to 44.
55—Generic, vacuum fitting/adapter for front end assembly 1
56—Clamp leg/lever
57—Cleat/rib male or female i.e. raised-embossed/lowered-debossed
58—pivot of 56
59—finger lever of 56
60—Fresh fluid tank
61—one contemplated fresh fluid spray port
62—one contemplated fresh fluid spray port
63—Channel connecting 60 and 62
64—Drive from a motor
65—Drive ribs
66—adaptor plate associated with 55.
67—battery pack
68 Nozzle alteration Pivot
69—friction or detent/ratchet/index between two pivoted parts such as 12 and 15
70—press plate
71—knuckle bow
72—Light
73—Laser/focused aiming light
74—Waste tank full and/or level indicator
75—Fresh fluid empty and/or level indicator
76—internal contact/contacts/strips/wires
77—anti-dribble pressure-cracking check-valve
78—external contact contacts/strips/wires
79—Skid guide
80—Contact(s)
81—Examplary Clip to secure first body/working unit to second body/working unit
82—Exemplary binding assembly clip and/or ring to facilitate assembly of front end assembly 1, that may also create a more durable nozzle when less durable materials are used for the main front assemble1, components.
83—Fold crease
84—fold over section
85—Hose conduit
87—Stiffening/assembly rib
88—Entry to 41, liner waste area, well/expansion tank/holding tank/soiled fluid reservoir from a nozzle area.

### DETAILED DESCRIPTION OF THE INVENTION

While the invention will be described in connection with several preferred embodiments, it will be understood that the invention is not limited to these embodiments. On the contrary, the invention includes all alternatives, modifications, combinations, and equivalents as may be included within the spirit and scope of the appended claims. The present invention relates generally to devices for cleaning surfaces. In the art of devices for cleaning surfaces, there exists a multitude of appliances that each serve a particular function. There are vacuums (that may or may not include a brush roll), there are sweepers (brush-roll only devices), and there are mops and wiper devices and there are brooms and dustpans and there are deep cleaners which are often used for soft surfaces such as carpets or upholstery. Each has their distinct advantages and disadvantages. The invention at hand seeks to inventively improve upon these devices in new and novel ways.

The present invention is a new and novel structure(s) for cleaning surfaces. A particular problem exists with pet and food messes and the like. Often the user spends a significant amount of time cleaning the machine that was used to clean the mess. These inventions address theses issues and more. Embodiments may include; a fresh fluid reservoir, a power containment module for optionally housing of an atmospheric (vacuum) pump, a fresh fluid pump,, batteries, a transformer, switches, a contaminated fluid/solids container of various constructs. There also may be a body with a handgrip and optionally with integral vacuum generating fan, and new and novel architecture or structural component arrangements of all the aforementioned items. Also disclosed are new and novel methods and structures for creating intake nozzles and waste storage structures whether they be permanent semi-permanent or disposable. Additionally, there are mechanisms and structures disclosed for constructing and moving a sweeping or scrubbing pad-type brush mechanism, constructing and moving and powering a generally flat, generally disc like or generally cylindrical brush roll, and moving the waste from one area to another.

### Some Selected Structural Objects and Claims of the Invention

All of theses disclosed optional embodiments and claims may combined and recombined without limitation.

One optional object, embodiment-and claim and object of the invention is to structurally enable a cleaner, which is modular structure.

Another optional object, embodiment- and claim of the invention is to structurally enable a cleaner where much of the mass of the cleaner is located at one location, a non-working end, and the rest is located at a location distal comprising a working end.

And a further optional object, embodiment-and claim of the invention where the non working end contains the batteries, the cleaning fluid reservoir, and the fluid pump, thereby limiting the weight of the working end, and making it easy to prime the pump and push fluid to the working end, and making it possible for a much larger cleaning fluid reservoir. Additionally, the non-working end may structurally include a transformer so could be AC/DC operable without adding weight to the working end. And further where the working end contains the motor/fan, and the recovery conduit and tank to optimize air-watts and minimize loses that occur using a hose for vacuum.

Another optional embodiment-object, embodiment and claim of the invention is to structurally enable a cleaner which may employ a receptacle for receiving soiled matter whether it be solids or liquids where that receptacle is disposable, recyclable, compostable/biodegradable, or reusable.

Another optional embodiment-object, embodiment and claim of the invention is to structurally enable a cleaner which may employ an intake port and optionally intake conduit to a receptacle for receiving soiled matter whether it be solids or liquids where that intake conduit is disposable, recyclable, compostable/biodegradable, or reusable.

Another optional object, embodiment and claim of the invention is to structurally enable a cleaner or a portion of a cleaner, where the durable and/or recyclable and/or compostable/biodegradable materials are selected from, cardboard, lined cardboard, a general/plurality of plastic materials, polyethylene, PET plastic; ABS plastic, and/or polypropylene plastic, steel, aluminum foil based product, wet pulp or dry pulp.

Another optional object, embodiment and claim of the invention is to structurally enable a cleaner where the receptacle for receiving soiled matter whether it be solids or liquids is constructed by folding of a material.

Another optional object, embodiment and claimed object of the invention is to structurally enable a cleaner where the receptacle for receiving soiled matter whether it be solids or liquids is constructed by molding of a material.

Another optional object, embodiment and claimed object of the invention is to structurally enable a cleaner where the receptacle for receiving soiled matter whether it be solids or liquids is constructed by thermoforming of a material where thermoforming is the process of heating a sheet of material, usually plastic, and then forming it (the material web) over a form(s) by draping, pressing upwards, pressing downwards, using vacuum from below, or pressure/air pressure from above, and then the process may also include secondary operations such as shape trimming, and punching of holes/openings etc. Some of the advantages of thermoforming are that it is extremely economical and can provide a high through rate and can form things in very thin wall thicknesses.

Another optional object, embodiment and claimed object of the invention is to structurally enable a cleaner where the receptacle for receiving soiled matter whether it be solids or liquids is constructed by stacking and connecting various structures together whether they be formed or folded.

These may be held together via molded flanges around the peripheral of the parts that are mechanically or adhesively bonded, or via molded snaps or snap channels, thereby creating extraordinarily economical structures. And so economical that these that may be disposed of or composted/biodegradable and furthermore, functionally convey to the user that this component(s) of the device are not precious, and are designed and intended to be “consumables”.

Another optional object, embodiment and claimed object of the invention is to structurally enable a cleaner where the front, intake end/front end assembly, FEA, that is generally comprised of an intake nozzle and debris and/or liquid holding tank that is semi-durable, and it is the users choice whether to open and empty (via a empty spigot, or opening of the subassembly) and/or dispose of the intake end.

Another optional object, embodiment and claimed object of the invention is to structurally enable a cleaner where the front intake/front end assembly, FEA, is generally comprised of an intake nozzle and a debris and/or liquid holding tank where either or both of the nozzle or debris/liquid holding tank is disposable and thus non openable without tools or component destruction.

Another optional object, embodiment and claimed-object of the invention is to structurally enable a cleaner where the nozzle for intaking soiled matter whether it be solids or liquids and the receptacle for receiving and holding soiled matter whether it be solids or liquids is constructed by a hybrid assembly of molded and folded product structures.

Another optional object, embodiment and claim of the invention is to structurally enable a cleaner capable of oscillating suction or building suction in a reservoir/tank to pulse.

Another optional object, embodiment and claim of the invention is to structurally enable a cleaner capable of adjusting intake orifices cross sectional (or other) area to alter the pick up capability from larger debris/higher air flow to smaller debris or liquid focused pickup-higher suction/vacuum lift. And so the intake nozzle for intaking soiled matter may be reconfigured to structurally optimize whether the material being picked up is dry or wet in nature by way of a variable (in cross section etc.) intake nose/nozzle.

Another optional object, embodiment and claim of the invention is to structurally enable a cleaner that may accept two differently configured front end assemblies, FEA, one structurally optimized for wet pick up/retrieval and the other optimized for generally dry pick up/retrieval where either, neither or both may be permanent/durable and user empty-able or disposable, or optionally disposable, and thus the user may or may not be able to open one or both without permanent destruction/alteration.

Another optional object, embodiment and claim of the invention is to structurally enable a cleaner which incorporates a brush which is molded from a singular material and which may be optionally separable/removable

Another optional object, embodiment and claim of the invention is to structurally enable a cleaner which incorporates a front end assembly, FEA, that operably and structurally slides on.

Another optional object, embodiment and claim of the invention is to structurally enable a cleaner which incorporates a front end assembly, FEA, that operably and structurally twists on.

Another optional object, embodiment and claim of the invention is to structurally enable a cleaner which incorporates a front end assembly, FEA, that operably and structurally is clamped or clipped on.

Another optional object, embodiment and claim of the invention is to structurally enable a cleaner which incorporates a front end assembly, FEA, that operably and structurally incorporates a debris scooper.

Another optional object, embodiment and claim of the invention is to structurally enable a cleaner which incorporates a front end assembly, FEA, that operably and structurally incorporates a larger debris scooper so that the user may use the same, optionally disposable, front end as a hand scooper, thus making it so that the user only has to have a grouping of a single renewable item to carry out multiple steps of a cleaning process. Such a scooper may be inventively molded as part of another part of the structure, and able to be snapped off or removed by the user thus resulting in greater economy and the functional messaging of the same.

Another optional object, embodiment and claim of the invention is to structurally create e a kit of parts that may include the following parts, a cleaner which incorporates a front end assembly, FEA, and a separate scooper. And a further object, embodiment and claim is where there is another kit of parts which may include a front end assembly, FEA, and an integral waste scooper.

Another optional object, embodiment and claim of the invention is to structurally create a front end assembly, FEA, that may be used with a plurality of vacuum sources and may include a filter and a modulating valve to limit the amount of suction transferred to optimize the operation of the front end unit/front end assembly, FEA.

Another optional object, embodiment and claim of the invention is to structurally create a system of a kit of parts with replaceable consumables that are economical to manufacture, deliver, use and are more environmentally friendly in through new structures, materials and ways and methods of both manufacture and structure.

Another optional object, embodiment and claim of the invention is to structurally create a structural system that limits the amount of fluid that can be put down and/or picked up in a given session, time period, or other measurable variable. In this way, suction may be maximized, relative to container (receptacle) size may be reduced and the potential of drawing waste fluid through the system beyond the waste receptacle is eliminated/reduced. This can be through the use of sorbants (as selective/changing blocking agents) or by creating timing circuits that limit the dispensing of fluid to certain total amounts based on a given variable such as time.

Another optional object, embodiment and claim of the invention is to structurally create a structural system that is an easy to use cartridge system. Cartridges may be comprised of :soiled reservoirs or fresh fluid reservoirs, or structural combinations of both soiled reservoirs and fresh fluid reservoirs.

Another optional embodiment-object, embodiment and claim of the invention is to structurally create a cleaner which may employ a dispensing system based on a foam to mitigate the amount of fluid that may bleed through the system whether a sorbant is used or not.

Another optional object, embodiment and claim of the invention is to structurally create a prerunner unit to a hosed deep cleaner that is constructed in a disposable format.

Another optional object, embodiment and claim-of the invention is to structurally create Constructs/structures that are not user serviceable/refill able drainable etc.

Another optional object, embodiment and claim of the invention is to structurally create an in tank sorbant approach versus expansion chamber to capture water and debris

Another optional object, embodiment and claim of the invention is to structurally create a cartridge system (with without sorbants) for a plurality of cleaning systems be they wet or dry or a combination of which; such as; carpet, bare floor, window cleaning, sweeping, vacuuming as well as others.

Another optional object, embodiment and claim of the invention is to structurally create Handhold/pressure plate, above the scrubber/pickup

Another optional object, embodiment and claim of the invention is to structurally create a cleaner with lighting and illumination of the area to be cleaned.

Another optional object, embodiment and claim of the invention is to structurally create a cleaner with a light source which may include ultraviolet light source to more readily identify stains to be cleaned.

Another optional object, embodiment and claim of the invention is to structurally create a cleaner with a light source that may be a Focused beam or laser to aid the user in pointing/aiming the fresh fluid/water/cleaner as it is being applied.

Another optional object, embodiment and claim of the invention is to structurally create Use of a dry or liquid concentrate in large tank or nose tank where user adds water

Another optional object, embodiment and claim of the invention is to structurally create A kit of parts and method of use where:

The parts may be shipped with a first disposable front end in place, whereby subsequent disposable front ends may be fitted up to the device by a user which may comprise a method of using the device.

Another optional object, embodiment and claim of the invention is to structurally create a fill sensor for waste container so larger fresh may be used with overflow-sensors that may protrude into waste tank through piercing plastic/paper/foils or may contact electrically conductive contacts made as part of a tank such as metals/foils or high carbon black paper/plastics. These fill sensor may provide visual, and/or audible feed back and/or cut off power to the vacuum and /r fresh fluid pump.

Another optional object, embodiment and claim of the invention is to structurally create Cyclonic air path within the disposable chamber., the expansion chamber and/or sorbant enhanced chamber

Another optional object, embodiment and claim of the invention is to structurally create a new sequential order of components resulting in newfound functionality.

Another optional object, embodiment and claim of the invention is to structurally create side saddle configuration that can hold the unit as one for storage

Another optional object, embodiment and claim of the invention is to structurally create as a modular contruct that can go from a separate bottled/battery tethered format to an all in one unitary unit, with shared components such as a body 10, assembly.

Another optional object, embodiment and claim of the invention is to structurally create Press/dispensing valve (shoe) assembly (ies) for pumpless (or pumped) dispensing of fresh fluid.

Another optional object, embodiment and claim of the invention is to structurally create a construction of a front end/FEA, 1, that may include both fiber and a “windowed” clear area for viewing contents.

Another optional object, embodiment and claim of the invention is to structurally create a construction of a front end/FEA, 1, that may include a break away(separate recyclable) fresh fluid container for separating the recyclable content from the disposable/biodegradable/compostable content.

Another optional object, embodiment and claim of the invention is to structurally create a construction that may include a Laser and/or focused lighting system for aiming fresh fluid spray while fresh fluid is operably switched on in a dispense mode.

### Background Art

Known configurations of the prior art put mechanicals such as the fresh fluid reservoir, the vacuum source, the fluid pump and power control and the waste reservoir into a base unit, and then remote the intake and fresh fluid distribution via a hose set to a distal location as can be seen in reference patent U.S. Pat. No. 9,615,703.

It is also known to put a pre-runner or pre-disposal tank at the end of a suction hose such as that of reference patent U.S. Pat. No. 8,230,550. It is also known to build a hoseless, handheld unit of unitary construction such as that disclosed in patent US2023/0148809, or U.S. 72,255,03B1 where all components are in a singular housing, and the user manipulates the entirety of the assembly to effect cleaning.

These overall known configurations or component architectures are in contrast with some embodiments of the disclosed invention, that structurally rearranges and thus enables new functionality by structurally rearranging and relocating key elements into new sub structures, and provides enabling structures to arrive at a here to for, new overall structural configurations and result.

Alternatively, other new and novel embodiments of the invention may be used with or in known structural configurations, yielding new beneficial results.

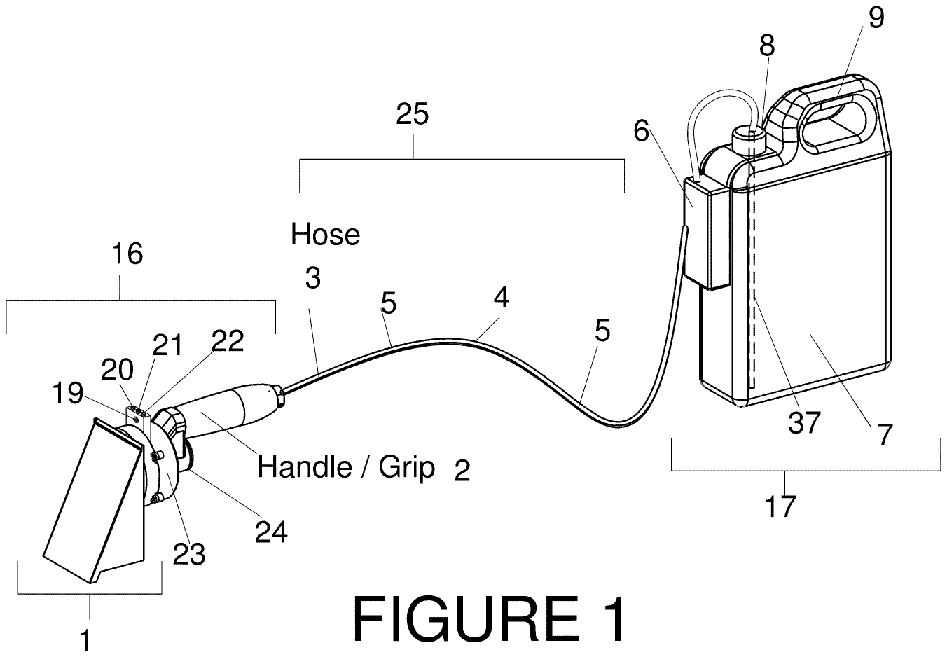

Referring to FIG. 1, a trimetric view of the invention can be seen This view offers general overall functionality/embodiment of some embodiments of the disclosed invention. Of note is that a unique configuration can be seen.

And so again referring to FIG. 1, there is a first working end of the device generally defined by reference character 16, which may be comprised of one example of a front end recovery assembly 1, and a vacuum assembly 23, and a motor 24, for driving 23, and a handgrip 2 in conjunction with control buttons 20-22 for manipulating and controlling the first unit/assembly of the device 16.

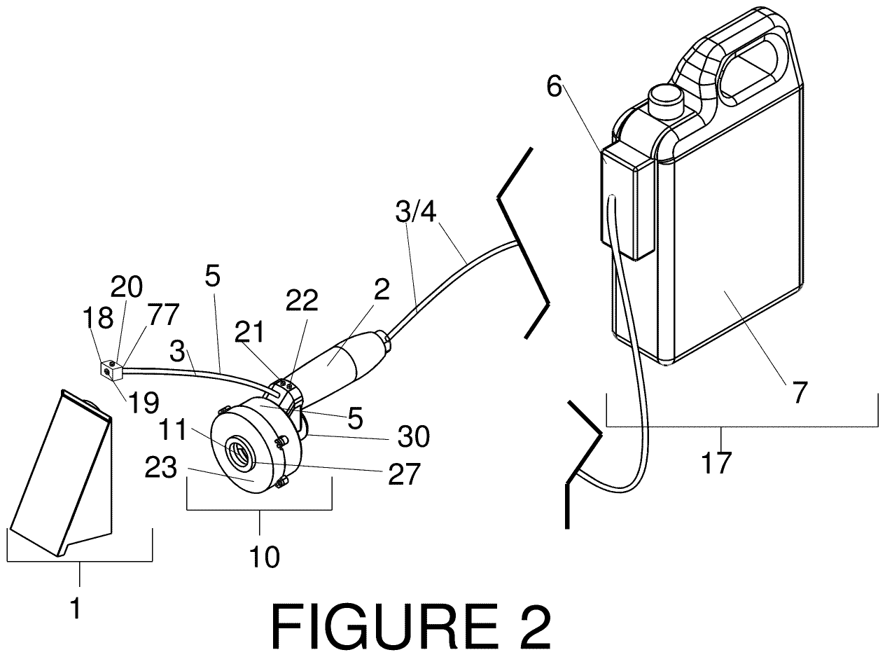

Second unit working end of the device is generally indicated by reference character 17. This second body/unit that is a main fresh fluid tank and contains a pump for pumping the fluid to the first working end, and has power supply components/converters, batteries or a.c. line cord and power management to power the first working end. And the first and second working ends are tethered by electrical and/or fluid conduits 4 and 3 and also generally indicated by reference character 25, which may include connection elements such as magnets/clips 5, for allowing the conduits to be separable, in cases such as a spray nozzle being remote-able (best seen in FIG. 2). Of note, is that by locating the motor 24, and its associated fan assembly 23, as well as, soiled fluid retention which occurs in 1, mechanical efficiency is maximized as air watts and losses through pipes/conduits, are reduced/eliminated versus a traditional configuration where the vacuum is located as part of a main unit (second working end) and suction is piped at distance. Furthermore, the maneuverability of the working end, body/handgrip 2, is maximized as it is not encumbered with a bulky, inflexible air hose/conduit leading back to a remote vacuum in section 17. And there is no hose to be dirtied and then necessitate cleaning. Furthermore, the unit is lightened versus a unitary design such as is exemplified by application US2023/0148809 and also unlike a unitary design, the hand maneuverable section is not burdened with the weight and bulk of having the fresh fluid in the working section (generally area 16) and larger fresh fluid supplies may be offered. Furthermore yet, the unit is lightened versus a unitary design as the pump and/or batteries may not need to be carried by the hand manipulaple section (generally area 16), yet the pump may still be in self-priming proximity. And further yet, the non working end may structurally include a transformer so could be AC/DC operable without adding weight to the working end.

And so some embodiments of this disclosure are directed at a cleaning implement that is lightweight and efficient in new ways due to: The device being made out of two main bodies,; the first body being the unit to be manipulated by the user which has a handgrip, a fresh fluid dispensing mechanism, the motor and impeller for retrieving soiled fluid, and a soiled fluid/solids reservoir, and, a second body/working end unit that is a main fresh fluid tank and contains a pump for pumping the fluid to 1st body working end unit, and has power supply components/converters, batteries or a.c. line cord and power management to the 1st body/working unit, and a tether line set operatively connecting the first body/working end unit and the second body/working end unit. In short, this new structural arrangement, distribution and enabling features disclosed in this and other associated embodiments, possesses the positive aspects previously known while concurrently avoiding the negative attributes of the prior art; thus yielding a new device with new optimized results. Additionally, by creating a handheld device, yet with greatly increased fresh fluid capabilities new functionality is realized. To increase the fresh fluid tank on a handheld unit, hand weight is increased. And furthermore, it has been found that the pick up of many units are only ⅓ of the fresh fluid dispensed, thus in this new configuration the fresh fluid container may be sized much without increasing thee hand weight of first working end. Contrast this to where there are two equally sized tanks in a single handheld assembly.

Referring to figure two we can see another embodiment of such a device. This embodiment is substantially similar to that of FIG. 1 however front end assembly, 1, can be seen separated, and it can be seen that sprayer assembly 18, and its associated actuator button 20, are structured to be removable and/or remote, thus providing greater convenience and control for the user to pre-wet, wet, and rewet the surface to be cleaned. Front end assembly 1, may be permanent or a disposable/consumable construction as will be outlined elsewhere in the disclosure. Also seen in figure two is Fluid conduit/hose 3 may include an anti-dribble pressure-cracking check-valve which requires a given pressure from the pump to open and thus prevent fluid from dribbling or siphoning from the system when not activated/desired. Pumps used throughout this disclosure may be one or more of several varieties; from gear, peristaltic, lobe, swash plate in addition to others unnamed. And such pumps may exhibit non-siphoning /on dribbling flow aspects via their geometries when in an off state for the already stated structural and result objectives.

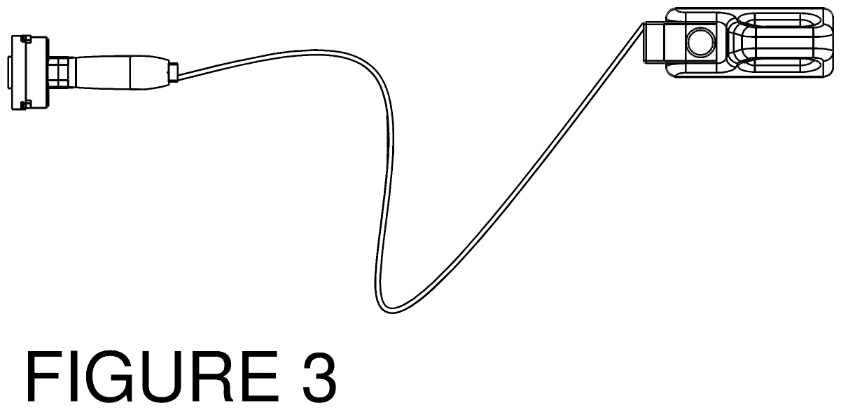

Referring to FIG. 3; FIG. 3 is a top view of FIG. 1 with the front end assembly removed.

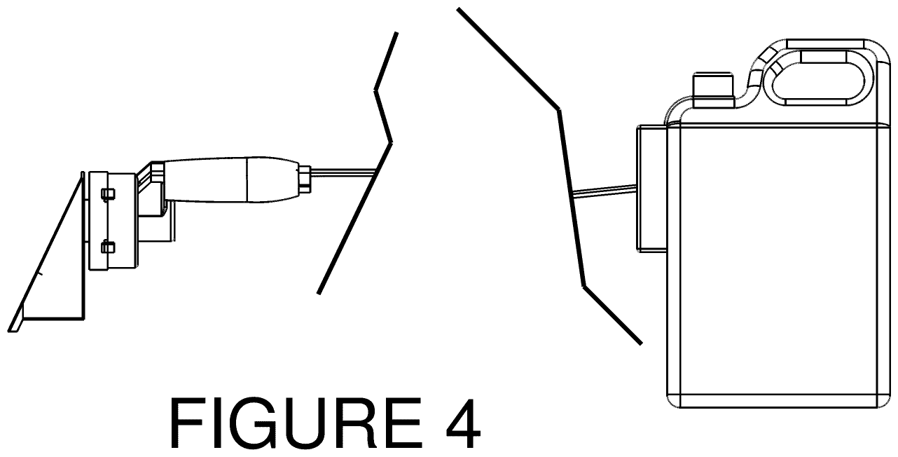

Referring to FIG. 4; FIG. 4 is a side view of FIG. 1 with the front end assembly assembled.

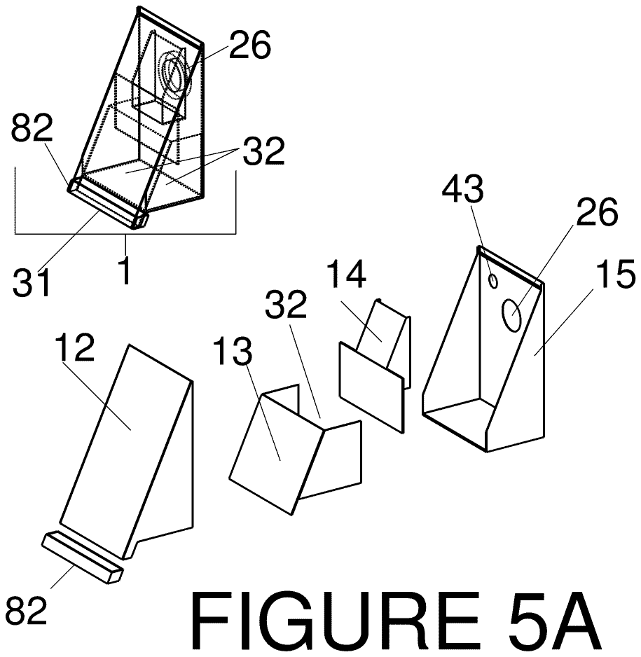

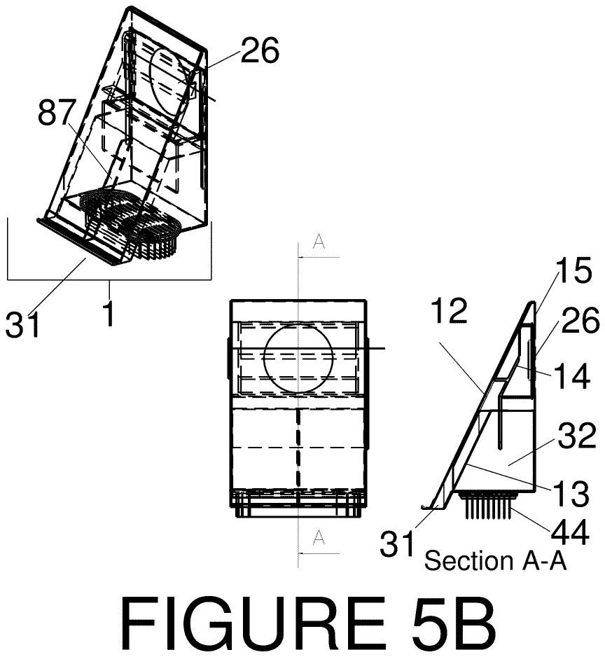

Referring to FIGS. 5A and 5B; FIGS. 5A and 5B shows an exemplary front end assembly/FEA and its construction. FIG. 5A shows an exploded view and a trimetric of an assembled view. FIG. 5B is a collection of an assembled trimetric view, a section view and a front view showing where section A-A is being taken from. Of note is that FIG. 5B depicts an assembly inclusive of an agitator and/or brush 44, and FIG. 5A does not. And so a front end of the embodiment disclosed with regard to FIGS. 5A and 5B, as well as other embodiments may be used in the novel configurations of FIGS. 1-4, as well as any of the other disclosed embodiments. As such, these novel disposable front ends may also be used with more traditional hosed units; where the vacuum motor and impeller is housed in a unit remote and hose-tethered to its intake. And so the novel front end tank assembly would be used in place of a nozzle in a dedicated manner, or in a temporary, user dictated-selective manner in periodic substitution of a traditional nozzle. The assembly itself, 1, can be seen indicated in both line and hidden line. It can be seen that by assembling units 12-15, a unitary, functional assembly 1, may be achieved. Of note is how it is the stacking or nesting of components that various structural and spatial volumes are completed out of partial pieces. For example part/surface 12 and part/surface 13 nest together to form intake nozzle structure/volume 31. And waste well area, well/expansion tank/holding tank/soiled fluid reservoir 32, is completed in its structural and spatial volume when nested/stacked/assembled with part of front end assembly 15. And baffle 14, creates a structural and spatial volume when nested/stacked/assembled part 15. These assemblies and subassemblies may be assembled using parts produced by injection molding, thermoforming (high-speed sheet) vacuum forming, folding, wet pulp or dry pulp molding, or combinations of which. Furthermore, materials may include thermoplastics, metals such as aluminum or steel, and pulp or paper-based product such as cardboard/fiberboard, wet pulp, dry pulp or combinations of these. One preferred embodiment uses thermoforming and or/folding/punching of sheet, as this can produce parts of extremely thin cross sectional thickness and at an extremely advantageous price point, which are both important structural design considerations when making an item that may be a “consumable” whether it be disposable, recyclable, or compostable/biodegradable. And assembly techniques, may include lamination, adhesives, snap fits, rivets, screws, folding for angles, folding via self-integral hings, ultrasonic bonding, and combinations of these. In this unique construction, it can be seen that item 12 and 13 are assembled to form the intake nozzle 31. And that item 13 may also form waste collection area/well 32. Baffle 14, can be seen as well as item 15, which forms, an area to affix the front end assembly 1, with the rest of the unit, the output port 26, and that with the item 12, forms the outer peripheral box assembly of the entire unit 1. And further it can be seen that item 82, exemplary binding assembly clip and/or ring, may be optionally used to facilitate assembly of front end assembly 1, by binding various components such as 12, and 13, so that a more durable nozzle may be created when less durable materials are used for the main front assembly 1, components. As such, 82, exemplary binding assembly clip and/or ring may be made of the same material as other components in the assembly, thus increasing thickness for durability, and/or be made of a differing material, thus increasing durability of that frictional and more highly stressed area of the unit 1. 82, exemplary binding assembly clip and/or ring assembly may also include bristles, and/or fins, and/or fingers to act as agitators for agitating the surface to be cleaned. And 82, may be user separable for separate recyclability and/or reuse with other front end assemblies 1. Another anticipated, and sometimes preferred embodiment is where the waste area, well/expansion tank/holding tank area 32, and intake nozzle 31 are distinct and separable parts/components.

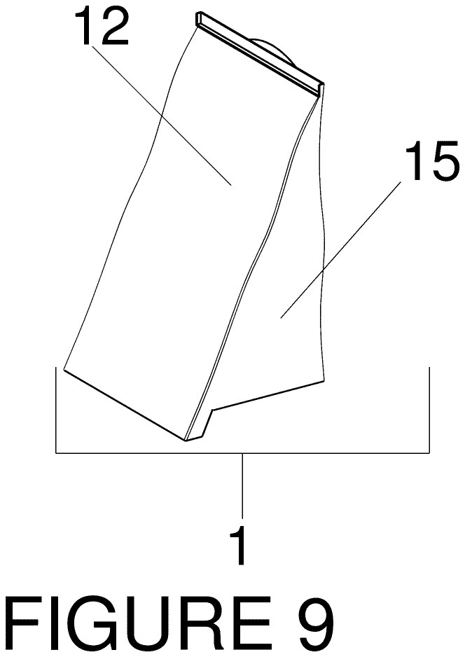

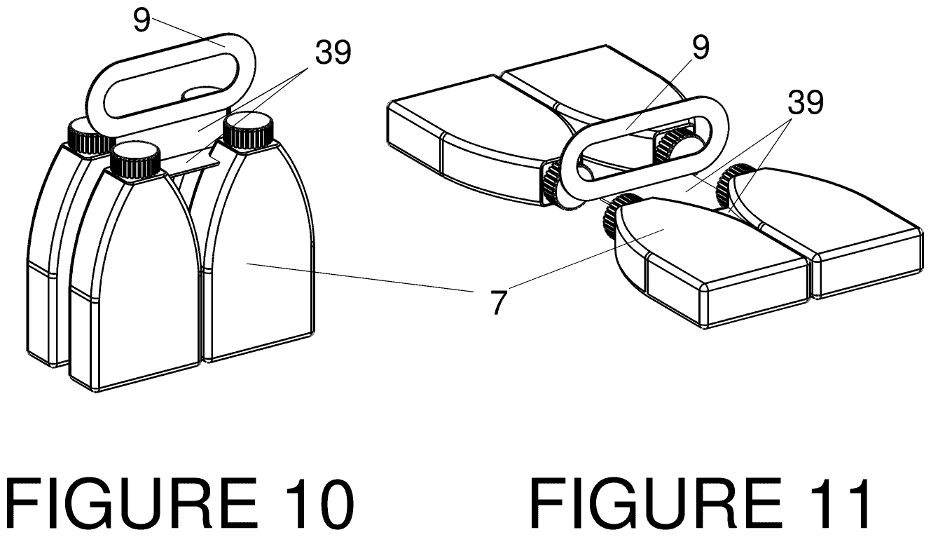

While this is one preferred embodiment/assembly, other derivatives are structurally anticipated. Such assembly, and any others disclosed herein, may include cylindrical or rounded or conical features to impart cyclonic separation within the front end assembly 1′s waste holding area, well/expansion tank/holding tank 32. Additionally, such assembly, and any others disclosed herein, may include sorbants such as pulp, (wood bamboo etc.) paper-fiber products such as paper towel, cloth, or sodium polyacrylates, or potassium polyacrylates to absorb the liquid when it is up taken into the waste holding area, well/expansion tank/holding tank area 32. Preferred embodiments use sodium polyacrylates, versus potassium polyacrylates as potassium poyacrylates can be an extreme environmental pollutant. Whereas sodium polyacrylates are relatively benign, being commercially used in products ranging from disposable diapers to freezer packs for food storage. These poyacrylate, generally “gelling” sorbants may be disposed in the well 32 area, or any other suitable area as solids or pebble or granular product. If the sorbants are cloth, or cloth-like, they may be hung like drapes or baffles or in the air flow path or placed over port/out put path 26 or wadded or made into pads/pillows to be placed into the waste tank area. If a powder/granular/pebble such as the aforementioned polyacrylates, they may be placed in various areas of unit 1, and further they may be housed in another structure such as a packet or sack, which is part of or placed within the waste tank structure 32. Alternatively, if it is cloth, or pulp, or fiber type material such as what is commonly referred to as “paper towel” it may be placed or packed, loosely or tightly in various areas of waste area, well/expansion tank/holding tank 32. This novel approach, has a plurality of benefits. It limits the amount of liquid that can be taken up in a given assembly. This can be matched, quantity wise, as will be seen in FIGS. 9 and 10, with fresh fluid tanks/units/vessels/cartridges thus making it difficult to overflow a recovery unit 1, and have fluid potentially go into the air intake fan, and motor causing damage etc. The amount and location of these sorbants can also serve to block off entry of additional fluid into the device unit, once the sorbant is “activated” and gels, or similarly block the fan port 26 and prevent any fluid from entering the fan assembly via 11, thus both protecting the device unit and alerting the user to change out the consumable portion of the device unit. Additionally the use of a sorbant(s) makes it much easier to dispose of a front end assembly, FEA, such as 1, into the garbage to be recycled or composted and not cause a mess by leaking soiled fluid everywhere. A problem with existing front runner/prerunner tanks is fluid leakage into parts upstream, i.e. back trough the nozzle, where the tank is tilted and there is back flow through the nozzle. Another problem with existing tanks is fluid leakage into parts downstream such as conduit or to the vacuum motor/impeller; again due to tilting of the tank in use, and also due to the foaming of the fluid and the inefficiency of having an expansion tank and associated baffles/air labarynth in a smaller size than other traditional, non-prerunner formats. And so, this new incorporation of sorbants into the tank area allows for a more efficient, leak proof, compact unit 1, to be produced, as it is not just the efficiency of the expansion tank/air labyrinth/baffles that are being relied upon for the removal of liquid from the airstream.

In addition to sorbants the use of products that possess the qualities of being Water Resistant, yet somewhat Air Permeable, herein and throughout this disclosure referred to as WRAP materials, is anticipated and disclosed within this disclosure. One example is perforated, spun bound, non woven high density polyethylene fiber-based product. Another is perforated plastic or screen, be it metal or plastic. These structures can allow the passage of air, yet have a filtering affect for water/liquid droplets. As with the novel use of sorbants, the incorporation of WRAP materials allows for a more efficient, compact unit 1, to be produced, as their unique properties enhance the efficiency and give new function to the air labyrinth/baffles for the removal of liquid from the airstream. These wrap materials may be hung like baffles, or wadded or made into pads/pillows in the tank area. And they may be used with or without other sorbants. Additionally, WRAP materials may be used over port/out put path 26 for similar water barrier/air permitting/filtering, structural reasons. Also seen in FIG. 5 is 43, attenuation valve, which may control amount of total suction front end assembly 1, experiences to avoid fluid escaping 1, to the rest of the system. It is an engineering balancing act to create enough suction for efficacy, but not so much as to overwhelm the efficacy capacity of the liquid-air separator section (often through an expansion tank arrangement) of a system. Other variables such as battery strength, tilt angle etc, can make for a moving target. An attenuator can balance out such variables.

An attenuator may also be employed to induce a pulsation of suction into the system to maximize fluid retrieval, by the remainder of the system (duct from front end assembly to the suction motor) having a suction build-up battery effect to create periods of greater or pulsed suction. Such a valve may be an inherent part of the assembly 1, as an overlying flap etc, or may be an added component/device.

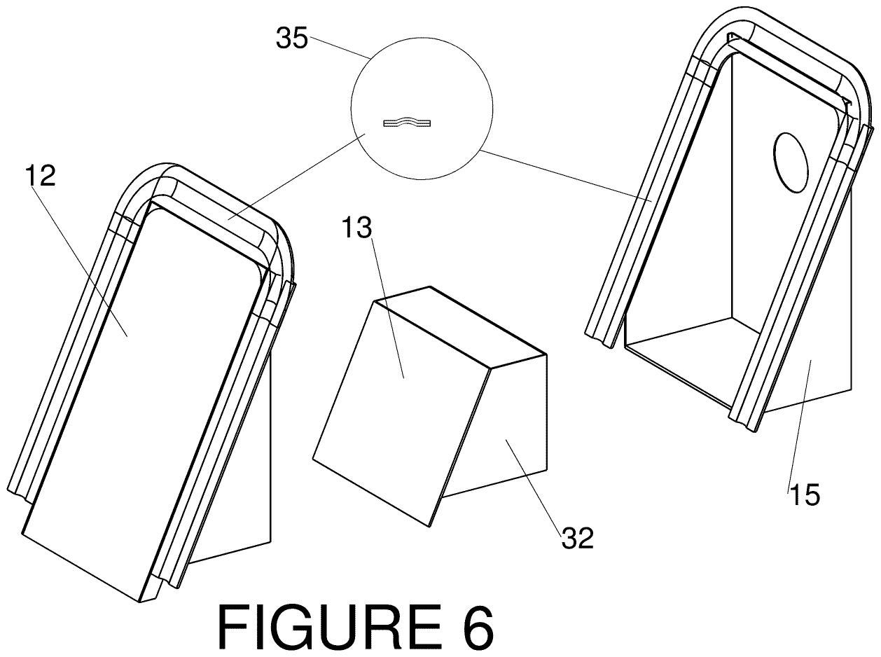

Referring to FIG. 6, another embodiment may be seen. Here it can be seen that one or more pieces may be held together by integral, press fit seams, that may form air or water tight, or near air and water tight, connectors for forming an assembly. It can further be seen that clamshells may be formed further in trapping other inner pieces so that only selected pieces may need the press fit seams/closures. Specifically in FIG. 6 can be seen that piece 12 and piece 15 may snap together via press fit internally molded closure shown in detail area 35, and in doing so they entrap one or more other pieces such as piece 13, forming a holistic assembly. These may be formed via a variety of processes such as injection molding, and extrusion, but in some preferred embodiments they are thermoformed from sheet stock.

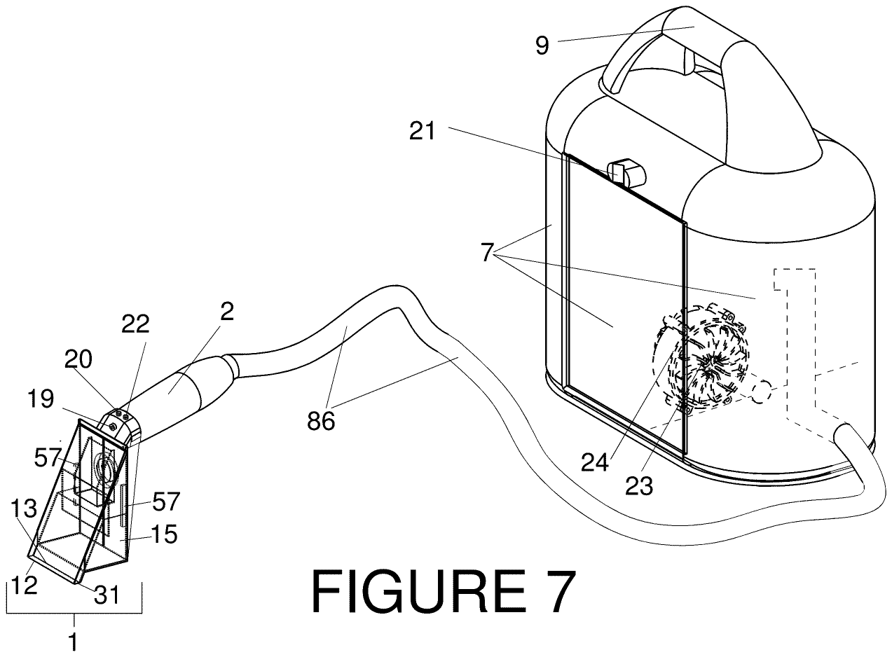

Referring now to FIG. 7, it can be seen that the front end assembly FEA 1, may be used with a hosed system. As such, the front end assembly FEA 1, may be constructed as has already been described in detail and removably attached to hose conduit 86, which may include a handgrip 2. In this way the front end assembly, FEA, acts as a pre-runner preventing the hose from conveying anything but air flow with all of the advantages of this construction already enumerated. And in alternative embodiments a known simple nozzle, that does not have a waste area, well/expansion tank/holding tank 32, may be removably attached to hose conduit 86. In this traditional configuration, waste liquid and debris is allowed to pass into hose conduit 86. And so in these alternative embodiments the user may choose which tool to use at the end of hose conduit 86, one that prevents soil from passing into hose conduit 86 by way of disclosed tank-based sorbants and may be made disposable, or a traditional nozzle that allows waste liquid and debris is allowed to pass into hose conduit 81 and into waste tank in the main unit where the vacuum motor 24, and vacuum assembly (impeller and housing) 23 are collocated or co-located with that tank.

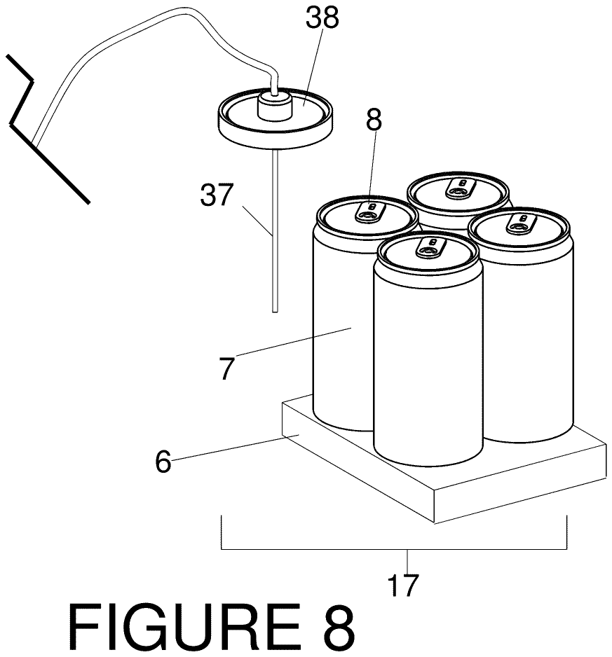

Referring now to FIG. 8, assembly 17, an alternative embodiment will be described. Here a single fresh fluid reservoir 7, or a multi-Pak of fresh fluid reservoir 7's can be seen as those upon power pack/base assembly 6. And an over-cap 38, and its draw tube 17, can be seen. Such an over-cap may be structurally configured to fit over a singular fresh fluid reservoir 7, or a multi-Pak. In this way, a user may be able to conveniently have multiple fresh fluid reservoirs ready to go, and the manufacture has the convenience and efficiency of multiple sales. As depicted, these reservoirs may be made in a familiar format such as an aluminum cans, and distributed via snap rings or cardboard etc, holders with handles. And aluminum it should be noted is the most efficiently and monetarily recyclable format and material presently known. In this way, a new level of convenience, efficiency, and recyclability has been introduced. Additionally, one or more of these cartridges may be configured to be concentrated, and/or mixed with one another in varying ratios, or diluted with water from another vessel. As such, some of these formats and embodiments alleviate the user from having to separately open a container and pour it into a permanent reservoir on one of the non-consumable parts of the cleaning device, leading to greater convenience, and reliability for the user.

Referring now to FIG. 9, another set of embodiments will be described. Of note is that body/handgrip/vacuum-motor assembly and/or vacuum hose end is omitted for clarity in this figure. Assembly 1, is a soft pack construct, that may also be a hybrid of soft and rigid/semi-rigid elements that will be fastened together as has already been described regard to other embodiments. And so, all or a portion of 1, may be constructed out of laminated material much like a disposable diaper, which may also include sorbants in the tank area(s) as has already been described earlier in and throughout this disclosure. Other portions of assembly 1, such as mounting features, air port 26, etc. may be made of a rigid material such as plastic/paperboard etc. These all may be, in whole or in part, recyclable, compostable and/or biodegradable, and/or disposable, and/or durable.

Referring to FIG. 10, an alternate embodiment to the multi-Pak of FIG. 8 can be seen. FIG. 10 shows how a multi-Pak may be formed as a unitary unit of multiple discrete and separate reservoirs. These may be formed in a variety of ways one of which is to be blow molded and another is a soft-pouch construction. They may be conjoined in a variety of ways one of which is to use integral webs 39 which may also include integral handle/handgrip 9. FIG. 11 shows how these units may be molded in alternate positions/orientations, and then the integral webs allow them to assume a more final form such as seen in FIG. 10.

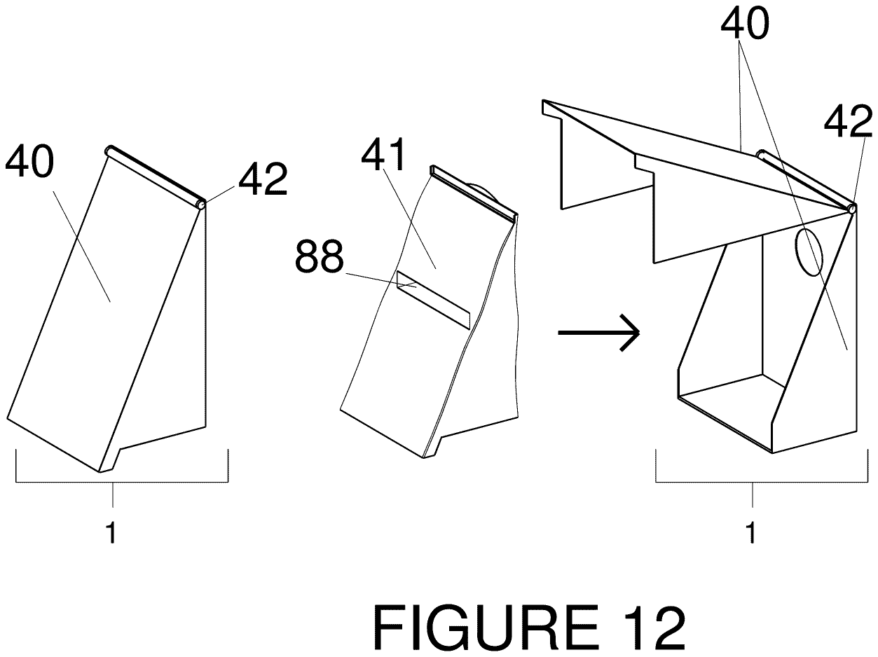

Referring now to FIG. 12. As previously disclosed with regard to other embodiments of the disclosure, assembly 1 may be durable, or disposable/single or limited use. If it is disposable, it may be emptied, or simply thrown away. FIG. 12 shows an alternative embodiment in that a portion of the assembly is not disposable, but may optionally include its own disposable liner. In this way the user can either use the removable reusable/non disposable debris tray or box, or tank, and optionally line it with a disposable liner 41 which acts as a waste area, well/expansion tank/holding tank/oiled fluid reservoir. And so the front end assembly may be made of a Master box 40, for receiving a consumable/semi-consumable element(s) 41. As previously described with regard to other embodiments, this disposable liner may be of soft material such as with regard to FIG. 9, or ridgid/semi ridgid construct; and may or may not include sorbant material. And this liner, at least in part, forms a replacement for the traditional holding tank for containing debris and liquid sucked up from a further upstream nozzle. The entry to the holding tank area of 41 is indicated by reference character 88. Furthermore, master box 40, can open in a hinged 42, way, or be slidably open able, or have a snap-clamshell construct, or other suitable means for replenishing its replaceable cartridge 41. Of note in one embodiment is how an intake nozzle may be created through the structural interface and void created by the front of the master box 40, and the non absorbant front face of the disposable liner 41 being selectively spaced from one another. In other embodiments, a complete intake nozzle may be a part of master box 40.

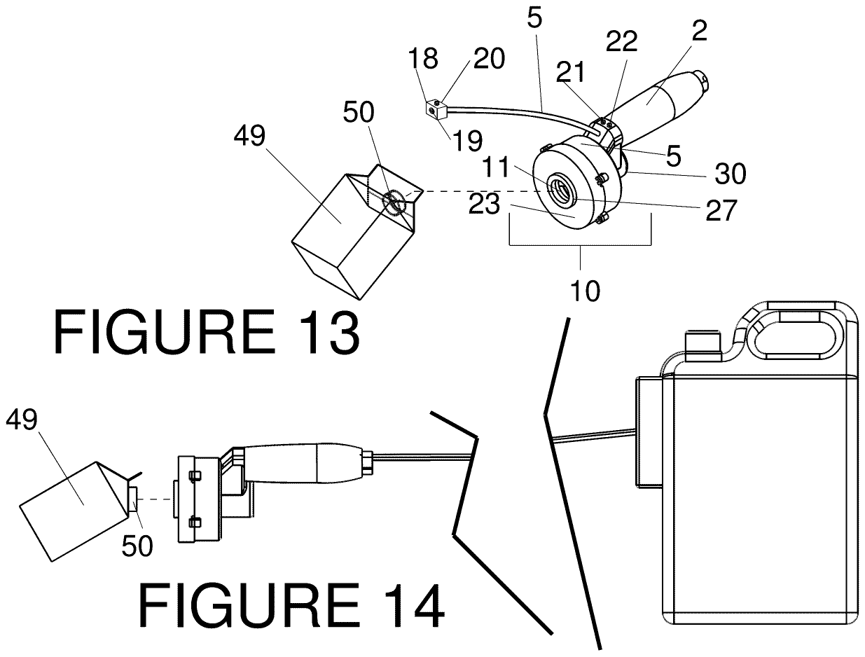

Referring now to FIG. 13 (trimetric) and FIG. 14 (side view) another embodiment may be seen. In this embodiment a Milk carton styled construct 49, can be seen. While this is a known packaging format, it makes for a unique structural construction for the device at hand. And while paperboard templates, forming and folding machines and integration of plastic spouts, 50, are readily available, the internal baffling and selective use of sorbants as has already been described/disclosed are inventively new and novel.

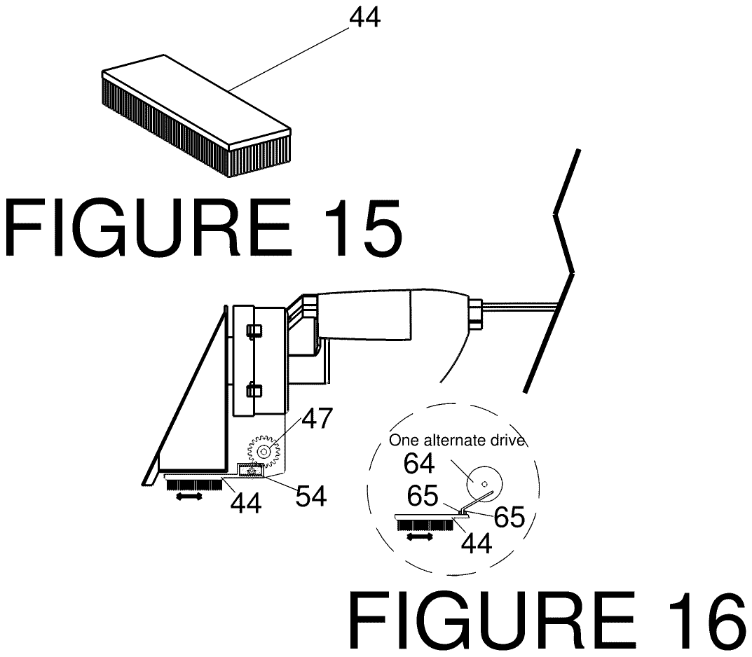

Referring now to FIG. 15 (trimetric)) another embodiment may be seen. In this embodiment there is a relatively planer brush that may be used in conjunction with the device and front end assembly 1. Such a brush may be economically (preferably injection molded) molded of a singular material (base and brush elements) and may be packaged kitted as was described with regard to scoop 33. Such a brush may be used alone, or may be affixed to the device and in a preferred embodiment it is either affixed to or formed as part of front end assembly 1 or one of its components. In this way the user may scrub the surface by hand either by using the brush 44 alone, or as a part of front end assembly 1. Furthermore, as the brush is economically molded it may be durable, or single use, recyclable, disposable or compostable/biodegradable.

Now referring to FIG. 16 a side view of another embodiment may be seen. Here generally planer brush 44, may be attached or translatably formed as part of front end assembly 1. It may be driven in a fore-aft scrubbing manner by motor/gear 47 driving mangle gear assembly 54, thus providing powered scrubbing. Alternatively motor may drive an offset crank assembly to effect for aft motion to the pad/planer brush. This is depicted within the dashed circle. Here too as the brush is economically molded it may be durable, or single use, recyclable, disposable or compostable/biodegradable.

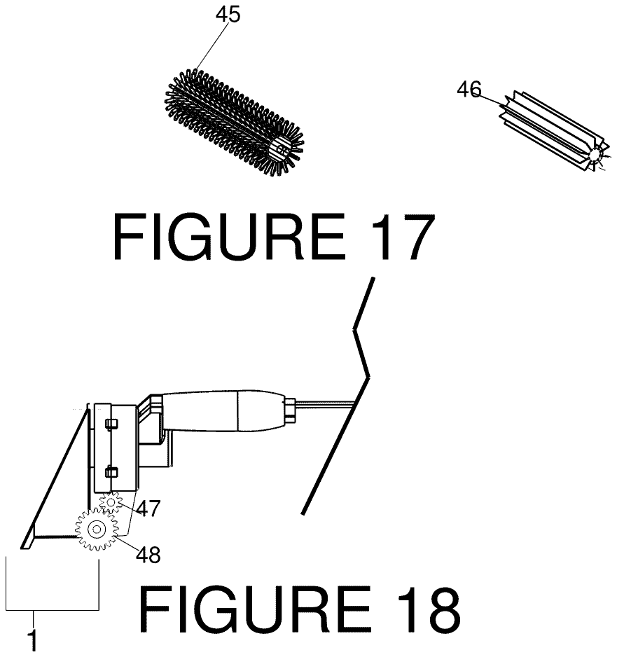

Referring now to FIG. 17 (trimetric) another embodiment may be seen. In this embodiment there is a relatively cylindrical brush 45/46 that may be used in conjunction with the device and front end assembly 1. Such a brush may be economically molded of a singular material (base and brush/fin-flap elements) (preferably injection molded). Referring now to FIG. 18 (side view) it can be seen how the brushes of FIG. 17 may be driven to effect cleaning. As gear brush 48 is part of front end 1, FEA, and drive gear 47 is part of the housing adjacent, front end assembly, FEA, gear 48 may be engaged/disengaged with gear 47 as the front end is assembled/removed from the rest of the unit. Additionally, the gear 48, may be molded as part of the singular molding of the brush 45/46.

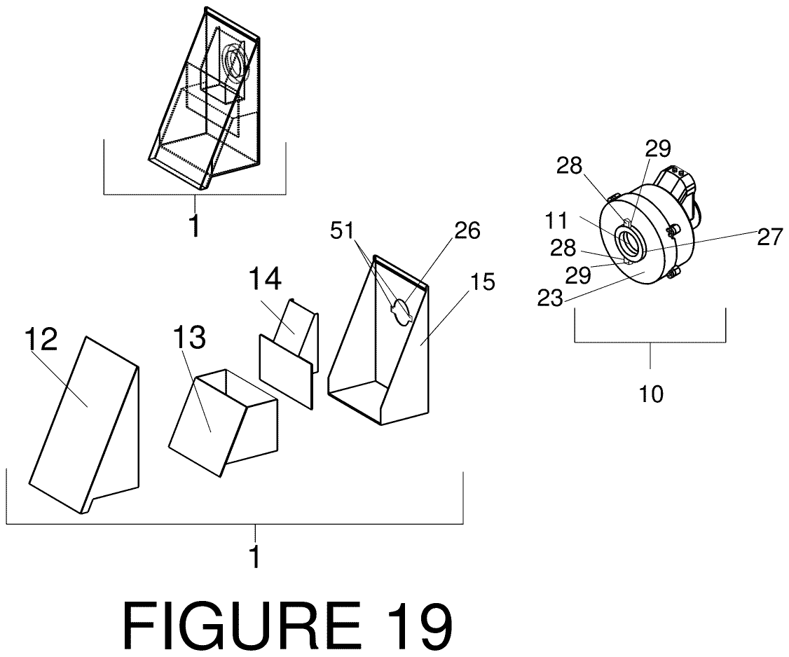

Referring now to FIG. 19 (trimetric) another embodiment may be seen. Here one of several embodiments of attaching/securing the front end assembly 1 FEA, will be disclosed. For simplicity only 10-Vacuum head assembly of shroud/motor/impeller, and not the handle-grip and/or hose end and/or other elements, depending on potential embodiments to be combined with, are shown in this figure. It can be seen that locking tabs, 28 have been structurally created on the attachment rim 27/vacuum port 11. These tabs may be further characterized as having lead in clamping/locking ramps 29. Mating area of front end assembly 1, best seen on piece 15, has formed/punched keyholes 51, which have an orientation rotated from the tabs 28, in this case a rotation of 90 degrees. So a user may assemble the two mating pieces, and turn (in this case ¼ turn) and the pieces are locked together. Lead in clamping/locking ramps 29, serve to further draw the parts together, making for a more leak proof fit and accounting for manufacturing tolerances etc. In this way, the features necessary in front end assembly one, can be produced simply and in line with some embodiments of single-use construction such as thermoforming, whereas the locking tabs 28, may be produced as part of section 10 via more detail oriented production techniques such as injection molding.

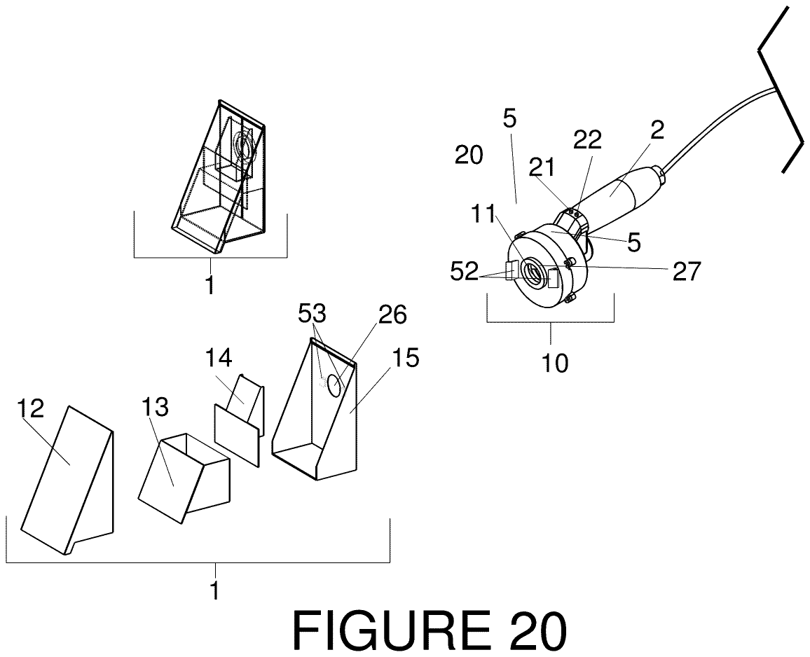

Referring now to FIG. 20 (trimetric) another embodiment may be seen. Here another of several embodiments of attaching/securing the front end assembly 1, will be disclosed. In this embodiment slide on hooks, 53, of front end assembly 1, vertically, slidably interface with slide on hooks 52 of Vacuum head assembly of shroud/motor impeller 10.

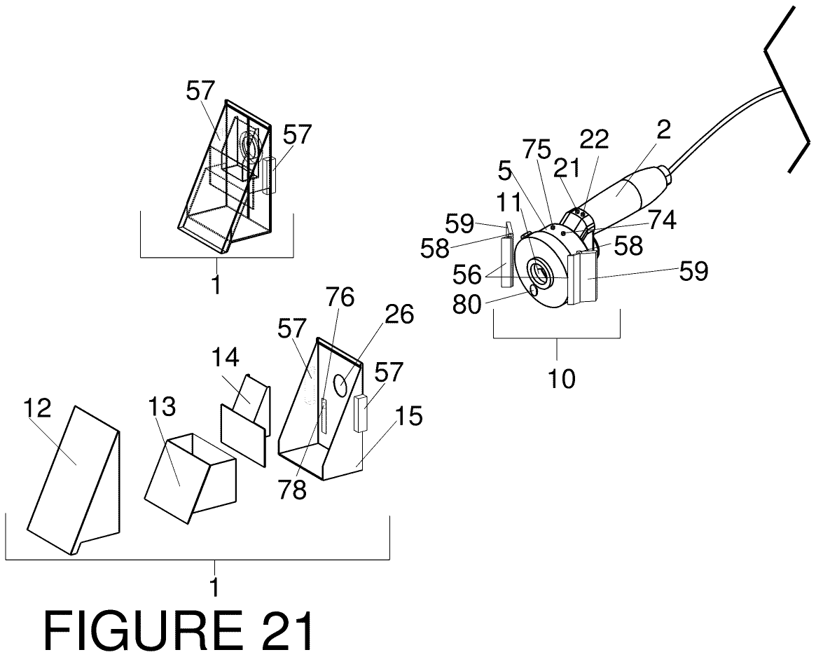

Referring now to FIG. 21 (trimetric) another embodiment may be seen. Here another of several embodiments of attaching/securing the front end assembly 1, will be disclosed.

57-Cleat/rib male or female i.e. raised-embossed/lowered-debossed can be seen as part of front end assembly 1, best seen on piece 15. Section 10 has clamping legs 56, on pieces (the entire clamping lever) that further include a pivot(s) 58, and finger levers 59. This whole clamping lever may be spring biased. And so the clamp, 56 may grip-clip the features 57 on 1/15. Making assembly and disassembly of front end unit 1, to the rest of the device 10, easy and convenient for the user. In this way, the features necessary in front end assembly 1, can be produced simply, more crudely, and in line with some embodiments of single-use construction such as thermoforming, whereas the locking tabs 28, may be produced as part of permanent section 10, via more detail oriented, and more costly, production techniques such as injection molding. And further they locking tabs may be adjustable (spring biased) to features such as 57, that may be variable due to their crudeness. And so the investment in the replaceable front end is minimized by putting the cost and precision in the non-disposable components and through these structural enablements.

Still referring to FIG. 21 various structural means for detecting fluid levels will be described. Novel embodiments that provide indication of when the front end, 1, is full is desirable, whether it be disposable or not and thus will be described. A simple not- full/full, sensing circuit may be employed as well as a more advanced circuit for discerning how full the unit is. In either case sensing is necessary and to internal contacts 76, may be employed to allow sensing of the circuit. These may be made of wires, or in a more disposable structural construction may be made of foil strips, molded in, or printed using conductive metal paint/ink or paint/ink or plastic with high content of carbon black or the like. There may also be external contacts 78, to, in this case, construct piece 15, and these may make contact with contact(s) 80, on vacuum head assembly 10, and thus communicating with aforementioned circuit and giving user appropriate feedback via 74, waste tank full and/or level indicator. A similar arrangement may be made with regard to the fresh fluid container(s) with the result being a user appropriate feedback via 75-Fresh fluid empty and/or level indicator.

The afore described structures are electrical in nature. In some cases it may be advantageous to create a construct of fluid level indication that is mechanical or chemical. Examples include floats, float tilt structures, paper/fiber or plastic flaps that pivot from fluid displacement, or wicking materials that change in appearance as a result of the level of fluid present. As such anticipated modes of fluid sensing structures include those that are electrical, or float-displacement indicator(s) or wick based, or chemically changing; all resulting in a unique user identifiable display of status.

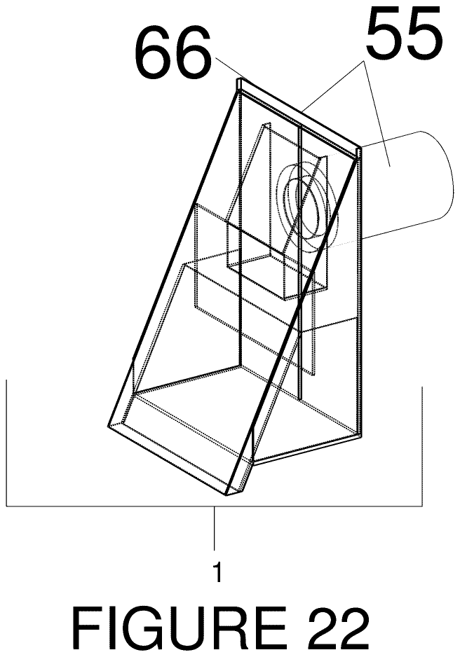

Referring now to FIG. 22 (trimetric) another embodiment may be seen.

This embodiment allows any vacuum source to be used with the new style front end assembly, FEA, 1. Adaptor plate 66 has a Generic, vacuum fitting/adapter 55 attached to it. Furthermore, this adaptor plate and its port adaptor 55, may use any of the aforementioned attachment structures (not depicted in this figure) described with regard to FIGS. 19-21, as well as others such as hook and loop fastener etc to attach front end assembly FEA 1. In an alternative embodiment, port adaptor 55 is made as a part of, optionally disposable, front end assembly FEA 1, thus the entire unit is disposable.

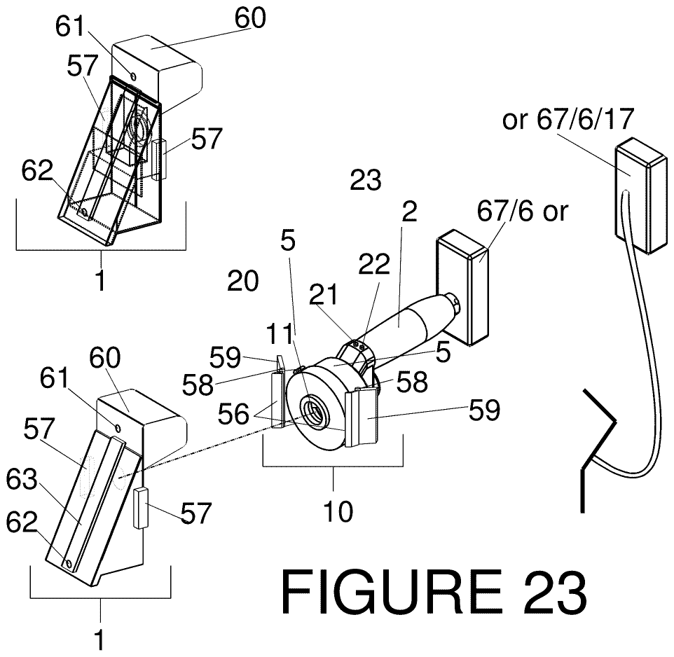

Referring now to FIG. 23 (trimetric) another embodiment may be seen. In this embodiment the front end assembly 1, further includes a fresh fluid tank 60. The fresh fluid may be delivered via a pump, to spray nozzles 61 or 62 as has already been described, or via valved gravity flow, or in an alternate embodiment, tank 60 is positively pressurized (aerosol as but one example) by the manufacturer or by way of an on board pump or the output air path of the vacuum impeller. Output is anticipated in potentially multiple locations 61/62, with enabling flow channels 63 that may be inventively formed inherent to the other components of the assembly. In this way an entire cartridge based system has been created. In some embodiments the consumer may purchase the unit prefilled with fluid and use it and then discard it. The volume size (in some cases 8 oz or less) of the fresh fluid section 60, may be matched with that of the recovery section already described. The fresh tank may be made as a separate unit and attached to the front end assembly, or it may be made holistically from the assembled layers/components already described with regard to other embodiments. As is other embodiments, such a cartridge system may be durable, or single use, recyclable, compostable/biodegradable, or reusable. As depicted in FIG. 23 the battery/power pack may located on the body/ handgrip portion of the unit (at a distal end for weight distribution) or alternately tethered remote as a second working unit 17, as has been described with other embodiments. In addition to other disclosed embodiments, such a system brings a new level of convenience and economy to the consumer and is structurally advantageous to produce for the manufacturer. While depicted in reference to hand manipulated cleaners; such a cartridge system and inventive embodiments of which are disclosed are also applicable to other forms of cleaners such as upright or canister style deep cleaners, as well as other cleaners such as hard surfaces/bare floor, window/mirror.

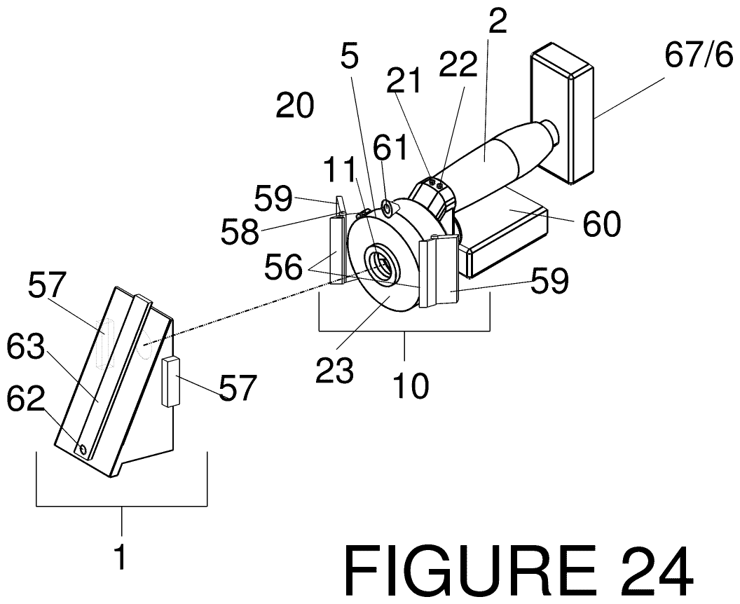

Referring now to FIG. 24, a figure similar to FIG. 23 may be seen, however this figure includes several alternative structural embodiments. The fresh fluid tank 60 has been moved to be generally behind and/or collocated/co-located with the vacuum head assembly of shroud/motor impeller 10. Of note is that the batteries may also be located within body/handgrip 2, and that fresh fluid tank 60 may be fill able/refillable or be a pre-filled cartridge system that is replaced as a whole.

And so some embodiments represented in FIG. 24 are of more singular structure 10, that includes a power source, batteries and fresh fluid. Accordingly, embodiments include those already described and also a device more singular in nature. Such a device may be made of some of the same components already described with regard to the first unit/working end, with components that were functionally in the second unit/working end. In this way a manufacturer may add to the line of product in a modular way with minimal additional tooling expense and the consumer enjoys a common operational functionality.

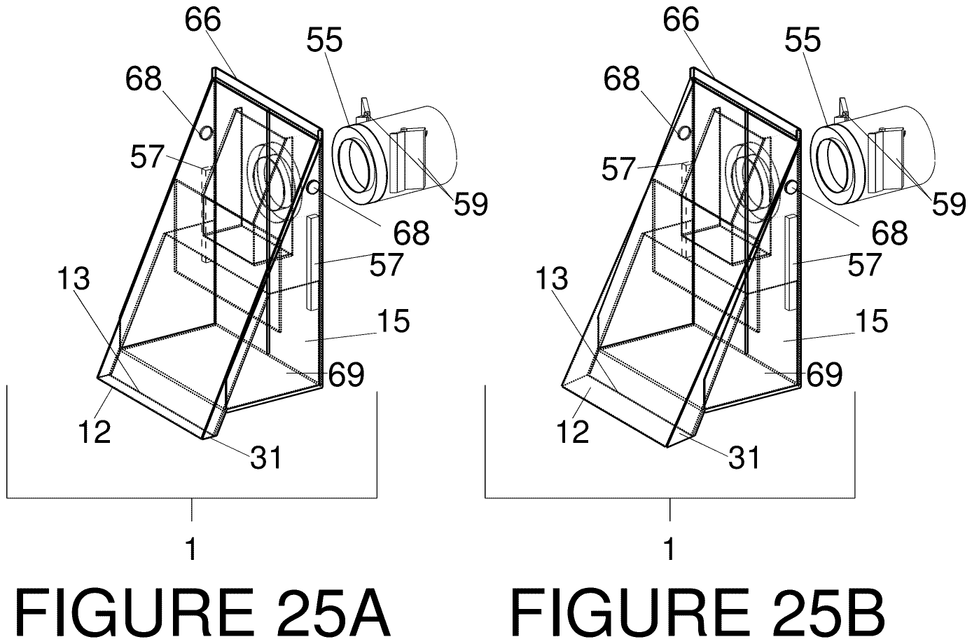

Referring now to FIGS. 25A and 25B one exemplary assembly that may change the square area of its intake nozzle will be structurally described. The ability to change addresses problems heretofore unanswered. Principally, in order to pick up solids of a given size, the intake must, at least in one dimension be equal to or greater than the given size of the debris/solids. At the same time, when picking up liquids, a much smaller cross section is required to concentrate the lifting/conveying action of the air movement.

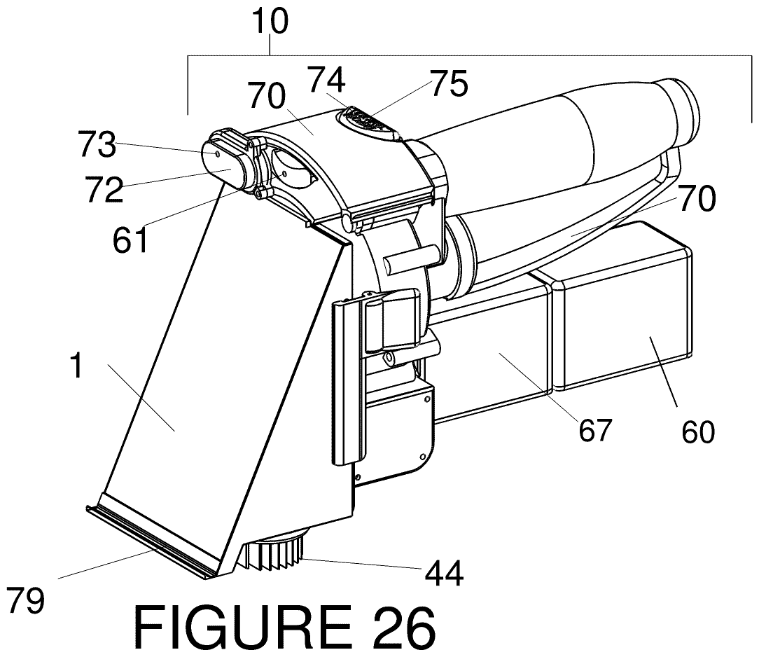

Referring again to FIGS. 25A and 25B, an assembly similar to as has been described with reference to FIGS. 5A and 5B can be seen. The structural relationships between piece 12 and piece 13 cooperatively create an intake nozzle 31. However now by structurally creating a pivot point 68 between component 12 and component 15, the cross sectional area of intake 31 may be altered as can be seen from FIG. 25A to FIG. 25B; where the intake 31 of FIG. 25B is greatly enlarged. Such alteration may be made by the user grasping a portion, or a handle/lever/button of the device and moving it into position or may be accomplished via an electromechanical arrangement (not shown) initiated by the user or by way of sensors arranged to detect the type of debris to be collected and making the appropriate change to the nozzle intake cross sectional area. Also shown is that 69-friction or detent/ratchet/index between two pivoted parts such as 12 and 15 may be structurally created to hold the pieces in their first and second relative positions. Also of note is that these figures show how an adapter 55, integral or separate, (as was described in other embodiments) may be used to couple the same front end unit (1) to both a bodied unit such as in FIG. 21 or 26 or to a vacuum hosed unit as previously described with reference to FIGS. 7 and 22. It should be noted that this active adaptive arrangement has application in other cleaning devices such as upright/canister vacuums, upright/canister deep cleaners and robotic floor, wall, window cleaners.

Referring now to FIG. 26, several other features and embodiments may be seen.

A main body 10, can be seen that includes a handgrip and a vacuum assembly.

Additionally press plate, 70 can be seen. Such a pressing area allows the user to ergonomically press down on the device to accomplish more active scrubbing.

Also seen in this view is knuckle bow, 70. Such a structure not only protects the user's hands, but also lends stability to the handgrip area enabling a lighter structure to be as strong as a materially heavier construct.

Lighting area 72, can be seen which may illuminate the area to be cleaned. Such a light may be incandescent or LED for normal illumination. Alternatively or additionally, this light may be ultraviolet, to illuminate stains that may not be as visible to the naked eye. Any of these lights may be turned on separately or in conjunction with the main unit being powered via switch (such as 21).

In the same area (but does not necessarily have to be so) Laser/focused aiming light 73 can be seen. The purpose of this is as an aiming aid for the user when spraying down fresh water/cleaning fluid via fresh fluid spray port 61 and/or 62. This aiming light/laser may be always active or only activated by/while fluid dispense button (such as 20) is activated.

Also seen in this view is an alternate waste tank full and/or level indicator 74 as has been described earlier with regard to FIG. 21. Alternate fresh fluid empty and/or level indicator 75, can also be seen. These indicators may be LED as lights, an LCD, as a display, or other indicia status indicator(s).

Also seen in this view is that structurally battery pack 67, is now closest to front assembly 1 with fresh fluid tank 60, more distal to front end assembly 1. Contrast this to FIG. 24 where the fresh fluid tank is more adjacent (or part of) front end assembly 1, and battery pack 67 is more distal to front end assembly 1. Each of these constructs, are separate embodiments of the invention structural features and advantages distinct to each such as, but not limited to, weight distribution and accessibility. Here too the assembly may be made of some shared common elements of other embodiments as a modular construct as has already been described.

Also seen in this view is brush assembly 44, as well as skid feature 79, which enables front end assembly 1, to not “catch” upon edges, upholstery, or carpet, and/or other surfaces to be cleaned.

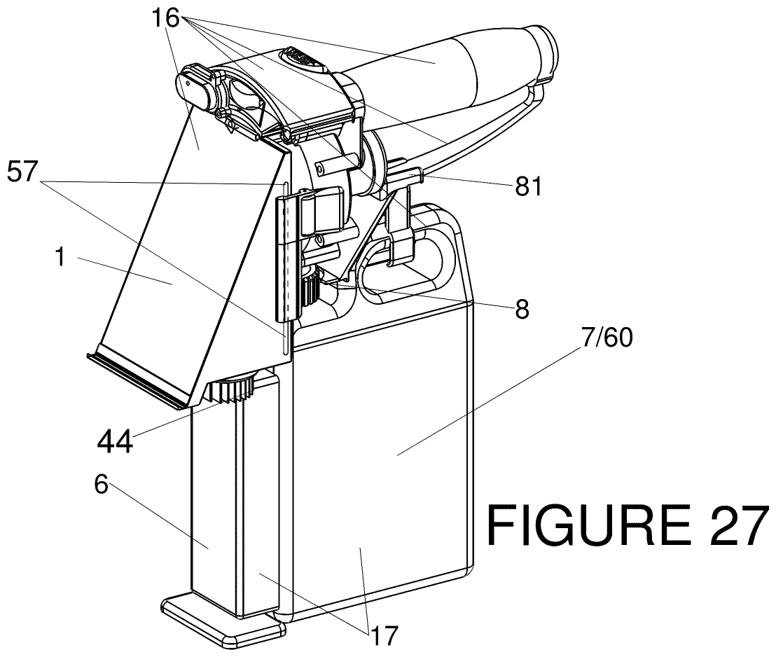

Referring now to FIG. 27 it can be seen how with embodiments that include first and second working ends, first working end, 16, may be nested, stacked, or hung on, second working end, 17 comprising a storage and/or carry to point of use position. Appropriate, clips, cord/hose raps, etc. may be provided for to selectively and intermittently secure the two units together.

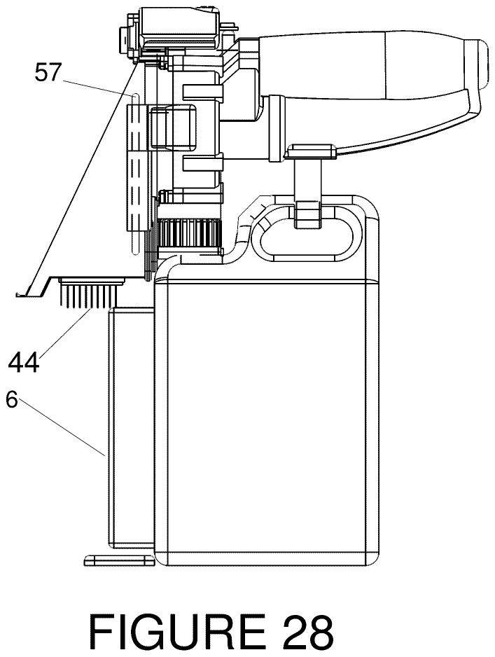

Referring now to FIG. 28 a side view of FIG. 26 can be seen.

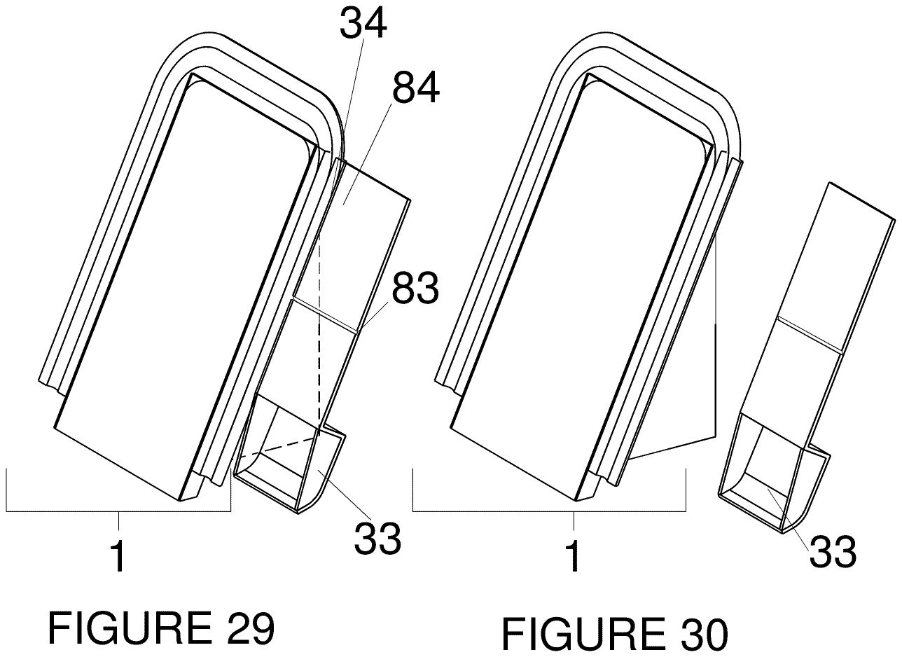

Referring now to FIGS. 29 and 30, an assembly generally as described with regard to FIG. 6 may be seen in assembled form. This embodiment shows that a snap off debris scoop(er) 33 may be integrally molded as part of another element of the invention. In this way the unit may be structurally constructed as a kit of parts for cleaning, disposable or not. FIG. 29 shows the front nose assembly/front end assembly FEA, 1, and the scooper 33 in assembled state, and FIG. 30 shows the scooper torn off (via perforations 34/or to be cut etc.) from the nose assembly/front end assembly 1. A separate scooper 33, not integrally molded with another part of the invention such as 1, but still forming a kit of parts, is also anticipated by this disclosure. Still referring to FIGS. 29 and 30, it can be seen that a fold over cover section 84, in a non-folded over depiction, has been structurally created to close off the scooper to more cleanly and hygienically dispose of the matter that was collected. Such a fold over cover 84 may snap close to secure the scoop 33 for disposal.

All of the disclosed embodiments, their features and structural characteristics may be combined and recombined without limit and still be within the sprit and scope of the disclosed invention(s).

What is claimed is:

1) A device for cleaning surfaces for use with an atmospheric based vacuum unit comprising: a holding tank upstream from said atmospheric based vacuum unit, an intake nozzle upstream from said holding tank, where said holding tank contains a sorbant, where when said intake nozzle picks up debris and liquid and it is passed to said holding tank, said sorbant absorbs said liquid, preventing said liquid, at least in part, from passing to said atmospheric based vacuum unit.

2) The device of claim 1, where said sorbant is comprised of at least in part a cellular based material.

3) The device of claim 2, where said cellular based sorbant is comprised of at least in part a wood pulp.

4) The device of claim 1, where said sorbant is comprised of at least in part sodium polyacrylates.

5) A device for cleaning surfaces comprising: an atmospheric based vacuum unit, a holding tank upstream from said atmospheric based vacuum unit, an intake nozzle upstream from and adjacent to said holding tank, where said holding tank contains a sorbant, where when said intake nozzle picks up debris and liquid and it is passed into said holding tank, said sorbant absorbs said liquid preventing said liquid, at least in part, from passing to said atmospheric based vacuum unit.

6) The device of claim 5, where said soiled fluid collection reservoir is constructed to be single use, and not able to be emptied by a user.

7) The device of claim 5, where said holding tank and said intake nozzle are a distinct and separable subassembly.

8) The device of claim 5, where said holding tank and said adjacent nozzle comprise a front end assembly.

9) The device of claim 8, where said front-end assembly is constructed at least in part of a fiber based material.

10) The device of claim 8, where said front-end assembly is constructed at least in part of a plastic based material.

11) The device of claim 8, where said front-end assembly is constructed at least in part of nested components.

12) The device of claim 8, where said front-end assembly is constructed at least in part of folded flatstock.

13) A device to be used to clean a surface comprising: a first working end, with a front end assembly comprising a nozzle and an adjacent soiled fluid reservoir, an atmospheric vacuum unit attached adjacent said front end assembly, and a handgrip attached to said vacuum unit, and distal to said first working end is a second working end comprising: a fresh fluid reservoir, and a pump, where said first working end and said second working end are connected by a conduit for transferring from said second working end, fresh fluid from said fresh fluid reservoir to said first working end.

14) The device of claim 13, further including a power output from said second working end and an electrical conduit connecting said second working end to said first working end for powering said vacuum unit.

15) The device of claim 13, where said soiled fluid reservoir contains a sorbant, where when said intake nozzle picks up debris and liquid and it is passed into said soiled fluid reservoir, said sorbant absorbs said liquid preventing said liquid, at least in part, from passing to said atmospheric based vacuum unit.

16) The device of claim 13, where said soiled fluid collection reservoir is constructed to be single use, and not able to be emptied by a user.

17) The device of claim 13, where said front-end assembly is constructed at least in part of a fiber based material.

18) The device of claim 13, where said front-end assembly is constructed at least in part of a plastic based material.

19) The device of claim 15, where said sorbant is comprised at least in part of a cellular based material.

20) The device of claim 15, where said sorbant is at least in part comprised of a sodium polyacrylates.
